(19) United States
(12) Patent Application Publication
(10) Pub. No.: US 2026/0016585 A1
(43) Pub. Date: Jan. 15, 2026

(54) MULTI-MODAL SENSOR LOCALIZATION SYSTEM

(71) Applicant: GM GLOBAL TECHNOLOGY OPERATIONS LLC, Detroit, MI (US)

(72) Inventors: Zijun Han, Madison Heights, MI (US); Jinzhu Chen, Troy, MI (US); Chuan Li, Troy, MI (US); Fan Bai, Ann Arbor, MI (US); Aaron Adler, Rochester Hills, MI (US); Bryan W. Fowler, Shelby Twp., MI (US); Malek D. Jaradi, Troy, MI (US)

(73) Assignee: GM GLOBAL TECHNOLOGY OPERATIONS LLC, Detroit, MI (US)

(21) Appl. No.: 18/772,817

(22) Filed: Jul. 15, 2024

(51) Int. Cl. G01S 13/06; B60W 30/09; G01S 13/02; G01S 13/931; H04B 17/318

(52) U.S. Cl. CPC G01S 13/06; B60W 30/09; G01S 13/0209; G01S 13/931; H04B 17/318

(57) ABSTRACT

Methods and systems are provided that include first sensors, second sensors, and a processor of a platform. The first sensors have a first modality, and are configured to obtain first sensor data as to a target with respect to the platform. The second sensors have a second modality that is different from the first modality, are configured to obtain second sensor data as to the target with respect to the platform, and for detecting the target at a relatively greater accuracy from short distances as compared with the first sensors of the first modality. The processor is configured for localizing the target using the first sensor data and the second sensor data, in which the second sensor data is utilized to enhance the first sensor data based on an effectiveness of the first sensor data, and that is based on a distance of the target from the platform.

### INTRODUCTION

The technical field generally relates to platforms such as vehicles and, more specifically, to methods and systems for localization of targets using sensors of multiple different types of modality.

Many vehicles and other platforms utilize sensors, such as ultra-wide band sensors, for localization of targets. However, in certain situations, such techniques may not always be optimal.

Accordingly, it is desirable to provide improved methods and systems for localization of targets in proximity to platforms, such as vehicles, using sensors of different modalities. Furthermore, other desirable features and characteristics of the present disclosure will become apparent from the subsequent detailed description and the appended claims, taken in conjunction with the accompanying drawings and the foregoing technical field and background.

### SUMMARY

In accordance with an embodiment, a method is provided that includes obtaining, via one or more first sensors of a platform, first sensor data as to a target with respect to the platform, the one or more first sensors having a first modality; obtaining, via one or more second sensors of the platform, second sensor data with respect to the target, the one or more second sensors having a second modality that is different from the first modality; and localizing the target, via a processor of the platform, using the first sensor data and the second sensor data, in which the second sensor data is utilized to enhance the first sensor data based on an effectiveness of the first sensor data, and that is based on a distance of the target from the platform; wherein the one or more first sensors of the first modality are configured for detecting the target at a relatively larger distance from the platform as compared with the one or more second sensors of the second modality; and the one or more second sensors of the second modality are configured for detecting the target at a relatively greater accuracy from short distances as compared with the one or more first sensors of the first modality.

Also in an embodiment, the platform includes a vehicle, and the processor is further configured to at least facilitate performing a control action with respect movement of the vehicle based on the localizing of the target with respect to the vehicle.

Also in an embodiment, the one or more second sensors of the second modality include ultra-wide band (UWB) sensors.

Also in an embodiment, the one or more first sensors of the first modality include RSSI sensors.

Also in an embodiment, the second sensor data is utilized via the processor to identify a plurality of candidate locations for the target; and the first sensor data is utilized via the processor to select a preferred candidate of the plurality of candidate locations based on pattern matching for the second sensor data using a path loss model.

Also in an embodiment, the localizing is performed via the processor using: only the first sensor data, and not the second sensor data, when the target is greater than a first predetermined distance from the platform; and both the first sensor data and the second sensor data, when the target is less than the first predetermined distance from the platform.

Also in an embodiment, the localizing is performed via the processor using: the first sensor data from a single first sensor of the first modality, when the target is greater than the first predetermined distance from the platform and is also greater than a second predetermined distance from the platform, wherein the second predetermined distance is greater than the first predetermined distance; and the first sensor data from multiple sensors of the first modality, when the target is greater than the second predetermined distance from the platform.

Also in an embodiment, the localizing is performed via the processor using: the first sensor data from multiple first sensors of the first modality, along with the second sensor data from a single second sensor of the second modality, when the target is less than the first predetermined distance from the platform but greater than a third predetermined distance from the platform, wherein the third predetermined distance is less than the first predetermined distance; and the first sensor data from multiple first sensors of the first modality, along with the second sensor data from multiple second sensors of the second modality, when the target is less than the first predetermined distance from the platform and less than the third predetermined distance from the platform.

Also in an embodiment, the localizing is performed via the processor using: the first sensor data from multiple first sensors of the first modality, along with the second sensor data from two second sensors of the second modality, when the target is less than the third predetermined distance from the platform but greater than a fourth predetermined distance from the platform, wherein the fourth predetermined distance is less than the third predetermined distance; and the first sensor data from multiple first sensors of the first modality, along with the second sensor data from at least three second sensors of the second modality, by applying triangulation with respect to the second sensor data from the at least three second sensors, when the target is less than the fourth predetermined distance from the platform.

In another embodiment, a system is provided that includes one or more first sensors of a platform, the one or more first sensors having a first modality and configured to obtain first sensor data as to a target with respect to the platform; one or more second sensors of the platform, the one or more second sensors having a second modality that is different from the first modality and configured to obtain second sensor data as to the target with respect to the platform, and wherein the second sensors of the second modality are configured for detecting the target at a relatively greater accuracy from short distances as compared with the first sensors of the first modality; and a processor of the platform that is coupled to the one or more first sensors and to the one or more second sensors and that is configured to at least facilitate localizing the target, using the first sensor data and the second sensor data, in which the second sensor data is utilized to enhance the first sensor data based on an effectiveness of the first sensor data, and that is based on a distance of the target from the platform.

Also in an embodiment, the platform includes a vehicle, and the processor is further configured to at least facilitate performing a control action with respect movement of the vehicle based on the localizing of the target with respect to the vehicle.

Also in an embodiment, the one or more second sensors of the second modality include ultra-wide band (UWB) sensors.

Also in an embodiment, the one or more first sensors of the first modality include RSSI sensors.

Also in an embodiment, the second sensor data is utilized via the processor to identify a plurality of candidate locations for the target; and the first sensor data is utilized via the processor to select a preferred candidate of the plurality of candidate locations based on pattern matching for the second sensor data using a path loss model.

Also in an embodiment, the localizing is performed via the processor using: only the first sensor data, and not the second sensor data, when the target is greater than a first predetermined distance from the platform; and both the first sensor data and the second sensor data, when the target is less than the first predetermined distance from the platform.

Also in an embodiment, the localizing is performed via the processor using: the first sensor data from a single first sensor of the first modality, when the target is greater than the first predetermined distance from the platform and is also greater than a second predetermined distance from the platform, wherein the second predetermined distance is greater than the first predetermined distance; and the first sensor data from multiple first sensors of the first modality, when the target is greater than the second predetermined distance from the platform.

Also in an embodiment, the localizing is performed via the processor using: the first sensor data from multiple first sensors of the first modality, along with the second sensor data from a single second sensor of the second modality, when the target is less than the first predetermined distance from the platform but greater than a third predetermined distance from the platform, wherein the third predetermined distance is less than the first predetermined distance; and the first sensor data from multiple first sensors of the first modality, along with the second sensor data from multiple second sensors of the second modality, when the target is less than the first predetermined distance from the platform and less than the third predetermined distance from the platform.

Also in an embodiment, the localizing is performed via the processor using: the first sensor data from multiple first sensors of the first modality, along with the second sensor data from two second sensors of the second modality, when the target is less than the third predetermined distance from the platform but greater than a fourth predetermined distance from the platform, wherein the fourth predetermined distance is less than the third predetermined distance; and the first sensor data from multiple first sensors of the first modality, along with the second sensor data from at least three second sensors of the second modality, by applying triangulation with respect to the second sensor data from the at least three second sensors, when the target is less than the fourth predetermined distance from the platform.

In another embodiment, a system is provided that includes a body, one or more first sensors, one or more second sensors, and a processor. The one or more first sensors are disposed within the body, have a first modality, and are configured to obtain first sensor data as to a target with respect to the platform. The one or more second sensors are disposed within the body, have a second modality that is different from the first modality, and are configured to obtain second sensor data as to the target with respect to the platform. The second sensors of the second modality are configured for detecting the target at a relatively greater accuracy from short distances as compared with the first sensors of the first modality. The processor is disposed within the body, is coupled to the one or more first sensors and to the one or more second sensors, and is configured to at least facilitate localizing the target, using the first sensor data and the second sensor data, in which the second sensor data is utilized to enhance the first sensor data based on an effectiveness of the first sensor data, and that is based on a distance of the target from the platform.

Also in an embodiment, the platform includes a vehicle, and the processor is further configured to at least facilitate performing a control action with respect movement of the vehicle based on the localizing of the target with respect to the vehicle.

### DESCRIPTION OF THE DRAWINGS

The present disclosure will hereinafter be described in conjunction with the following drawing figures, wherein like numerals denote like elements, and wherein:

FIG. 1 is a functional block diagram of a platform, such as a vehicle, that includes a control system that includes systems of different modalities, and a processor that is configured to localize targets in proximity to the platform using the sensors of the different modalities, in accordance with exemplary embodiments;

FIG. 2 is a flowchart of a process for localizing targets in proximity to a platform, such as a vehicle, using sensor data from sensors of different modalities, and that can be implemented in connection with the vehicle of FIG. 1, in accordance with exemplary embodiments;

FIG. 3 is an illustration of various stages utilized in an implementation of the process of FIG. 2, in accordance with exemplary embodiments;

FIG. 4 is a flowchart of an exemplary sub-process of the process of FIG. 2, namely localization in particular first and second stages of FIG. 3, in accordance with exemplary embodiments;

FIG. 5 is a flowchart of another exemplary sub-process of the process of FIG. 2, namely localization in particular third and fourth stages of FIG. 3, in accordance with exemplary embodiments; and

FIGS. 6, 7, 8A, 8B, 9A, 9B, and 9C depict exemplary implementations of pattern matching associated with steps of the process of FIGS. 2-5 (including a pattern matching step described in FIG. 5), in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

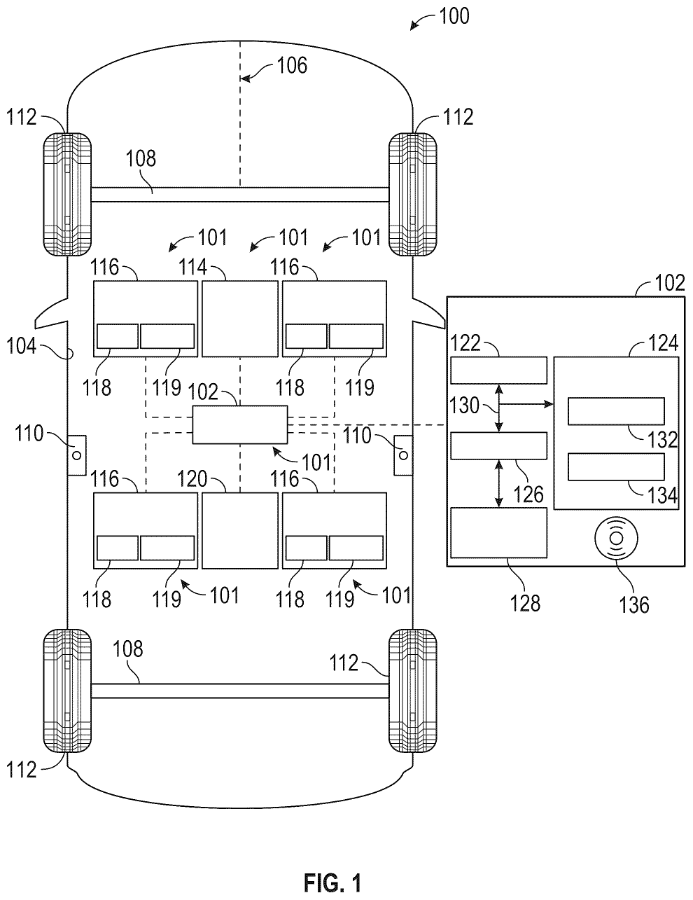

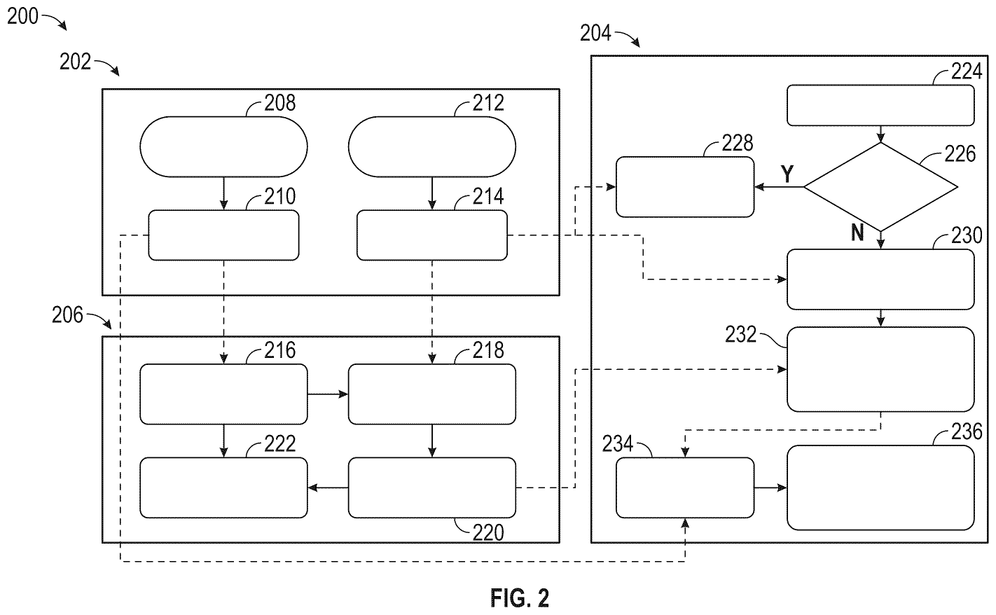

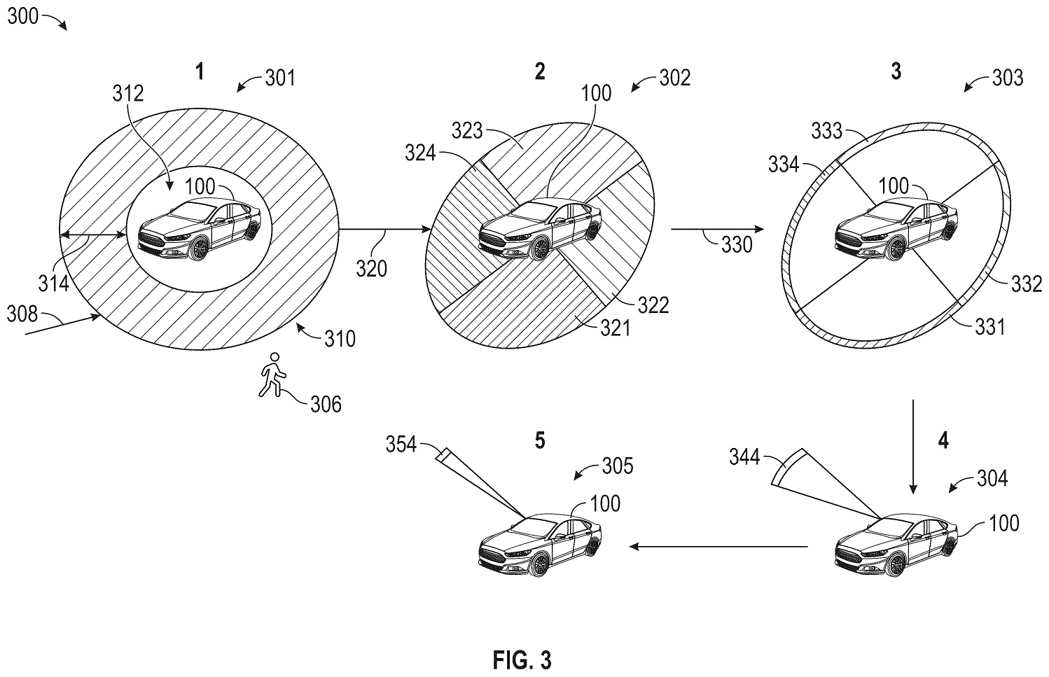

FIG. 1 illustrates a platform 100, according to an exemplary embodiment. As described in greater detail further below, the vehicle 100 includes, among other components, a plurality of sensors 116 of different modalities and a controller 102 that provides localization of targets in proximity to the platform 100 using the sensors 116 of the different modalities. As described in greater detail further below in connection with FIG. 1 as well as the process 200 of FIG. 2 and the sub-processes and implementations of FIGS. 3-9(C), in various embodiments the controller 102 utilizes different combinations of the different types of sensors 116 under various stages of conditions, and performs various different algorithms for localization depending to the different states.

In various embodiments, the platform 100 comprises a vehicle, and is also referred to herein as the vehicle 100. In various embodiments, the vehicle 100 comprises an automobile, such as any one of a number of different types of automobiles, such as, for example, a sedan, a wagon, a truck, sport utility vehicle (SUV), or the like. In certain embodiments, the vehicle 100 may also comprise a motorcycle or other vehicle, such as aircraft, spacecraft, watercraft, and so on, and/or one or more other types of mobile platforms (e.g., a robot and/or another mobile platform). While the term “vehicle” 100 is used throughout this application, it will be understood that in various embodiments the platform 100 may comprise any number of mobile platforms (such as those noted above) or non-mobile platforms (such as for example, one or more mobile phones or other electronic devices, one or more buildings, other structures, other devices or systems, and so on).

In the depicted embodiment, the sensors 116 include a first sensor type 118 and a second sensor type 119. In various embodiments, the first sensor type 118 can detect targets within a relatively greater distance from the vehicle 100 as compared with the second sensor type 119. Conversely, also in various embodiments, the second sensor type 119 has greater accuracy of detection of targets as compared with the first sensor type 118, at least when the target is in close proximity to the vehicle 100.

In certain embodiments, the first sensor type 118 comprises radio signal strength indication (RSSI) sensors, with a range or approximately thirty to forty meters (30-40 m). Also in certain embodiments, the second sensor type 119 comprises ultra-wide band (UWB) sensors, with a range of approximately fifteen meters (15 m). However, this may vary in other embodiments.

As depicted in FIG. 1, in an exemplary embodiment, the vehicle 100 also includes a body 104 that is arranged on a chassis 106. The body 104 substantially encloses other components of the vehicle 100. The body 104 and the chassis 106 may jointly form a frame. The vehicle 100 also includes a plurality of wheels 112, as referenced above, that are each rotationally coupled to the chassis 106 near a respective corner of the body 104 to facilitate movement of the vehicle 100. In various embodiments, the vehicle 100 also includes a plurality of doors 110.

A drive system 114 is mounted on the chassis 106, and drives the wheels 112, for example via axles 108. In certain embodiments, the drive system 114 comprises a propulsion system having one or more motors (not depicted in FIG. 1, and for example that includes, in various embodiments, one or more combustion engines, electric motors, or the like). In certain embodiments, the drive system 114 may also include or be coupled to a braking system, a steering system, and/or one or more other systems of the vehicle 100.

In various embodiments, the vehicle 100 also includes one or more display systems 120. In certain embodiments, the one or more display systems 120 provide displays and information for a driver and/or users of the vehicle 100, including as to the localization of targets in proximity to the vehicle 100 and/or one or more other vehicle control actions taken in connection therewith. In various embodiments, the display system 120 may provide audio, visual, haptic, and/or other types of notifications.

As depicted in FIG. 1, in certain embodiments the sensors 116 and the controller 102 may collectively be considered or referred to as a control system 101 that controls localization of targets in proximity to the vehicle 100, and that in various other embodiments also controls other aspects of vehicle functionality (e.g., control actions such as propulsion, braking, steering, and so on).

Also as depicted in FIG. 1, in various embodiments, the controller 102 is coupled to the sensors 116, along with the drive system 114, display system 120, and other vehicle systems, and executes the steps of the process 200 of FIG. 2 and the sub-processes and implementations of FIGS. 3-9C, as described in greater detail further below in connection therewith.

As depicted in FIG. 1, in various embodiments, the controller 102 comprises a computer system (also referred to herein as computer system 102), and includes a processor 122, a memory 124, an interface 126, a storage device 128, and a computer bus 130.

The processor 122 performs the computation and control functions of the controller 102, and may comprise any type of processor or multiple processors, single integrated circuits such as a microprocessor, or any suitable number of integrated circuit devices and/or circuit boards working in cooperation to accomplish the functions of a processing unit. During operation, the processor 122 executes one or more programs 132 contained within the memory 124 and, as such, controls the general operation of the controller 102 and the computer system of the controller 102, generally in executing the processes described herein, such as the process 200 of FIG. 2 and implementations of FIGS. 3-9(C) and as described further below in connection therewith.

The memory 124 can be any type of suitable memory, including various types of non-transitory computer readable storage medium. In certain examples, the memory 124 is located on and/or co-located on the same computer chip as the processor 122. In the depicted embodiment, the memory 124 stores the above-referenced program 132 along with stored values 134 (e.g., look-up tables, thresholds, and/or other values with respect to the process 200).

The interface 126 allows communication to the computer system of the controller 102, for example from a system driver and/or another computer system, and can be implemented using any suitable method and apparatus. In one embodiment, the interface 126 obtains the various data from the sensors 116, among other possible data sources. The interface 126 can include one or more network interfaces to communicate with other systems or components. The interface 126 may also include one or more network interfaces to communicate with technicians, and/or one or more storage interfaces to connect to storage apparatuses, such as the storage device 128.

The storage device 128 can be any suitable type of storage apparatus, including various different types of direct access storage and/or other memory devices. In one exemplary embodiment, the storage device 128 comprises a program product from which memory 124 can receive a program 132 that executes one or more embodiments of one or more processes of the present disclosure, such as the steps of the process 200 of FIG. 2 and implementations of FIGS. 3-9(C) and as described further below in connection therewith. In another exemplary embodiment, the program product may be directly stored in and/or otherwise accessed by the memory 124 and/or a disk (e.g., disk 136), such as that referenced below.

The bus 130 serves to transmit programs, data, status and other information or signals between the various components of the computer system of the controller 102. The bus 130 can be any suitable physical or logical means of connecting computer systems and components. This includes, but is not limited to, direct hard-wired connections, fiber optics, infrared and wireless bus technologies. During operation, the program 132 is stored in the memory 124 and executed by the processor 122.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 122) to perform and execute the program.

FIG. 2 is a flowchart of a process 200 for localizing targets in proximity to a platform, such as a vehicle, using sensor data from sensors of different modalities, in an exemplary embodiments. In various embodiments, the process 200 can be implemented in connection with the vehicle 100 of FIG. 1, including the sensors 116, controller 102, and other components thereof.

As depicted in FIG. 2, in various embodiments the process 200 begins as the vehicle 100 is stationary and a target approaches the vehicle 100. However, this may vary in other embodiments.

As depicted in FIG. 2, the process 200 utilizes three models; namely: (1) a sensing model 202; (2) a localization model 204; and (3) a prediction model 206, as described in greater detail below.

In various embodiments, as part of the sensing model 202, first measurements are obtained (step 208). In various embodiments, the first measurements of step 208 comprise sensor data from the sensors 116 of the first type 118 of FIG. 1. In various embodiments, these comprise measurements that have relatively greater distance, but relatively less accuracy from short range, as compared with sensor data form the sensors 116 of the second type 119 of FIG. 1. In certain embodiments, the first measurements of step 208 comprise meter-level measurements from a plurality of RSSI sensors of the vehicle 100. Also in certain embodiments, initial determinations of the location of a target are obtained or determined with respect to the first measurements (step 210) (e.g., with respect to initial RSSI location determinations).

Also in various embodiments, and also as part of the sensing model 202, second measurements are obtained (step 212). In various embodiments, the second measurements of step 212 comprise sensor data from the sensors 116 of the second type 119 of FIG. 1. In various embodiments, these comprise measurements that have relatively smaller distance, but relatively greater accuracy from short range, as compared with first sensor data form the sensors 116 of the first type 118 of FIG. 1. In certain embodiments, the second measurements of step 212 comprise centimeter-level measurements from a plurality of ultra-wide band (UWB) sensors of the vehicle 100. Also in certain embodiments, initial determinations of the location of a target are performed via two-way ranging with respect to the second measurements (step 214) (e.g., with respect to initial UWB location determinations).

In various embodiments, feature extraction is performed (step 216). In various embodiments, the processor 122 of FIG. 1 performs feature extraction from the first measurements of step 208 and the initial determinations of step 210 (e.g., from the RSSI sensors, in an exemplary embodiment). In various embodiments, the feature extraction pertains to detection and initial localization of one or more targets (e.g., one or more people, other vehicles, and/or other objects) in proximity to the vehicle 100.

Also in various embodiments, real-time training is provided (step 218). In various embodiments, during step 218, real-time training is performed via the processor 122 of FIG. 1 with respect to the localization of the target using the various sensors 116, based on the feature extraction of step 216 and the initial determinations of step 214. I

Also in various embodiments, a path loss model is updated (step 220). In various embodiments, during step 220, the processor 122 of FIG. 1 updates a path loss matter for the sensors 116 of the first type 118 (e.g., RSSI sensors), using the real-time training of step 218.

Also in various embodiments, region detection is performed (step 222). In various embodiments, during step 222, the processor 122 performs region detected for the detected target using only the sensors 116 of the first type 118, providing that the target is at least a predetermined distance away from the vehicle 100. As described in greater detail further below in connection with FIG. 3, in various embodiments this corresponds to scenarios in which the target 306 of FIG. 3 is far enough from the vehicle 100 such that the current situation is either in stage one 301 or stage two 302, as depicted in FIG. 3 and as described in greater detail further below in connection therewith. Also in various embodiments, one or more vehicle control actions are then provided for the vehicle based on the localization of the target, such as (A) providing one or more notifications for a driver or other passengers of the vehicle 100 via the display system 120 of FIG. 1 (e.g., one or more audio, visual, and/or haptic notifications) in accordance with instructions provided by the processor 122); and/or (B) executing one or more vehicle movement commands for adjustments to motor/propulsion torque, braking torque, and/or steering angle via the drive system 114 (and/or one more motors, braking systems, steering systems, and/or other systems thereof or coupled thereto) in accordance with instructions provided by the processor 122.

In various embodiments, as part of the localization model 204, signal aggregation is performed (step 224). In various embodiments, during step 224, the processor 122 of FIG. 1 collects and aggregates signals from sensors 116 of the second type 119 of FIG. 1 (e.g., UWB sensors, in an exemplary embodiment), provided that the target is close enough to the vehicle 100 to be detected by the sensors 116 of the second type 119 (i.e., in certain embodiments, when the target is less than a predetermined distance from the vehicle 100). In various embodiments, this corresponds to stage three 303, stage four 304, and stage five 305 of FIG. 3, as described in greater detail further below in connection therewith.

In various embodiments, a determination is made as to whether the number of sensors 116 of the second type 119 that currently detect the target is greater than or equal to a predetermined threshold (step 226). In various embodiments, this is determined by the processor 122 of FIG. 1. For example, in various embodiments, certain particular sensors 116 of the second type 119 may not be able to detect the target if the target is too far from the particular sensors 116, and/or if the particular sensors 116 (e.g., UWB sensors) are blocked from detecting the target from one or more individuals or objects between the target and the particular sensors 116, and so on. Also in one exemplary embodiment, the threshold of step 226 is three, such that the determination of step 226 is whether there are at least three sensors 116 of the second type 119 that detect the target.

In various embodiments, if it is determined in step 226 that the number of sensors 116 of the second type 119 that detect the target is greater than or equal to the predetermined threshold of step 226 (e.g., at least three UWB sensors, in an exemplary embodiment), then the process proceeds to step 228. In various embodiments, during step 228, triangulation is performed for the location of the target using the sensors 116 of the second type 119 (e.g., the three UWB sensors, in an exemplary embodiment). Also in various embodiments, the triangulation of step 228 is performed via the processor 122 of FIG. 1 using the signal aggregation of step 224 as well as the initial determinations of step 214. In addition, in an exemplary embodiment, the triangulation of step 228 is performed under conditions that Also in various embodiments, one or more vehicle control actions are then provided for the vehicle based on the localization of the target, such as (A) providing one or more notifications for a driver or other passengers of the vehicle 100 via the display system 120 of FIG. 1 (e.g., one or more audio, visual, and/or haptic notifications) in accordance with instructions provided by the processor 122); and/or (B) executing one or more vehicle movement commands for adjustments to motor/propulsion torque, braking torque, and/or steering angle via the drive system 114 (and/or one more motors, braking systems, steering systems, and/or other systems thereof or coupled thereto) in accordance with instructions provided by the processor 122. correspond stage five 305 of FIG. 3, as described in greater detail further below in connection therewith.

Conversely, in various embodiments, if it is instead determined in step 226 that the number of sensors 116 of the second type 119 that detect the target is less than the predetermined threshold of step 226 (e.g., two or fewer UWB sensors, in an exemplary embodiment), then the process proceeds instead to step 230. In various embodiments, during step 230, potential locations (also referred to herein as candidate locations) for the target are identified by the processor 122 of FIG. 1 using the available sensors 116 of the second type 119 (e.g., the one or two UWB sensors, in an exemplary embodiment).

Also in various embodiments, following step 230, predictions are performed with respect to the candidate locations (step 232). In various embodiments, the predictions are performed with respect to the different candidate locations of step 230 based on data from the sensors 116 of the first type 118 of FIG. 1 (e.g., RSSI sensors), using the pass loss model of step 220.

Also in various embodiments, pattern matching is performed (step 234). Specifically, in various embodiments, the processor 122 of FIG. 1 performs pattern matching for each of the candidate locations of step 230, using the predictions of step 232 in addition to the initial determinations of step 210. In various embodiments, the pattern matching utilizes data from the sensors 116 of the first type 118 (e.g., RSSI sensors) in order to effectively evaluate the candidate locations that were identified by the sensors 116 of the second type (e.g., UWB sensors), in order to select the candidate location that is believed with the highest level of certainty to be the most accurate.

In various embodiments, location selection is performed (step 236). In various embodiments, the location selection of step 236 is performed under conditions that correspond stage three 303 and stage four 304 of FIG. 3, as described in greater detail further below in connection with FIG. 3. Also in various embodiments, one or more vehicle control actions are then provided for the vehicle based on the localization of the target, such as (A) providing one or more notifications for a driver or other passengers of the vehicle 100 via the display system 120 of FIG. 1 (e.g., one or more audio, visual, and/or haptic notifications) in accordance with instructions provided by the processor 122); and/or (B) executing one or more vehicle movement commands for adjustments to motor/propulsion torque, braking torque, and/or steering angle via the drive system 114 (and/or one more motors, braking systems, steering systems, and/or other systems thereof or coupled thereto) in accordance with instructions provided by the processor 122.

As alluded to above, FIG. 3 is an illustration 300 of various stages utilized in an implementation of the process 200 of FIG. 2, in accordance with exemplary embodiments.

As depicted in FIG. 3, the first stage 301 (as referred to in the process 200 of FIG. 2) occurs when the target is at least a first predetermined distance away from the vehicle 100 (or, in various embodiments, away from particular respective sensors 116). In various embodiments, passive scanning 308 is performed by a single one of the sensors 116 of the first type 118 (e.g., RSSI sensors), and not by any sensors 116 of the second type 119. Also in various embodiments, the distance between the target 306 and the vehicle 100 (or form the particular respective sensors 116) is too great for the sensors 116 of the second type 119 (e.g., the UWB sensors) to detect the target 306, and is also too great for additional sensors 116 of the first type 118 (other than the single sensor 116 of the first type 118 that is able to detect the target 306). Also in various embodiments as depicted in FIG. 3, the target 306 is just outside a first (outer) region 310 surrounding the vehicle 100, and is well outside a second (inner) region 312 surrounding the vehicle 100. Also as depicted in FIG. 3, there is a resulting error 314 in location accuracy.

Also as depicted in FIG. 3, the second stage 302 (also as referred to in the process 200 of FIG. 2) occurs when the target is less than the first predetermined distance away from the vehicle 100 (of the first stage 301) but greater than a second (relatively smaller) predetermined distance away from the vehicle 100 (or, in various embodiments, away from particular respective sensors 116), such that the target 306 is now within the first region 310 surrounding the vehicle 100. In various embodiments, passive scanning 320 is performed by multiple sensors 116 of the first type 118 (e.g., multiple RSSI sensors, who are each now able to detect the target 306), and not by any sensors 116 of the second type 119. Also in various embodiments, the distance between the target 306 and the vehicle 100 (or form the particular respective sensors 116) is still too great for the sensors 116 of the second type 119 (e.g., the UWB sensors) to detect the target 306, although now multiple sensors 116 of the first type 118 (e.g., RSSI sensors) are able to detect the target 306. Also as depicted in FIG. 3, each of the multiple sensors 116 of the first type 118 provide scanning and localization for the target 306 in different respective corresponding regions 31, 322, 323, and 324, each corresponding to a different respective one of the sensors 116 of the first type 118.

Also as depicted in FIG. 3, the third stage 303 (also as referred to in the process 200 of FIG. 2) occurs when the target is less than both the first predetermined distance (of the first stage 301) and the second predetermined distance (of the second stage 302) away from the vehicle 100 (or, in various embodiments, away from particular respective sensors 116), such that the target 306 is now within the section region 312 surrounding the vehicle 100. However, in the third stage 303, the target 306 is still a sufficient distance (i.e., greater than a third predetermined threshold) away from the vehicle 100 (or sensors 116) (or, in certain embodiments, has an obstructed path from certain sensors 116 of the second type 119) such that only a single one of the sensors 116 of the second type 119 (i.e., a single UWB sensor) is able to detect the target 306. In various embodiments, activation 330 is performed with respect to a single one of the sensors 116 of the second type 119 (e.g., a single UWB sensor) that provides detection and localization for the target 306. In addition, as depicted in FIG. 3, within the third stage 303 the localization is also assisted by continued scanning and localization of the target 306 by multiple sensors 116 of the first type 118 (e.g., multiple RSSI sensors), for example corresponding to different regions 331, 332, 333, and 334 as illustrated in FIG. 3.

Also as depicted in FIG. 3, the fourth stage 304 (also as referred to in the process 200 of FIG. 2) occurs when the target is still closer (i.e., less than the third predetermined threshold distance of the third stage 303) from the vehicle 100 (or, in various embodiments, away from particular respective sensors 116), such that detection and localization of the target 306 can now be performed by two (and only two) of the sensors 116 of the second type 119. However, in the fourth stage 304, the target 306 is still a sufficient distance (i.e., a fourth predetermined distance) away from the vehicle 100 (or sensors 116) (or, in certain embodiments, has an obstructed path from certain sensors 116 of the second type 119) such that only two of the sensors 116 of the second type 119 (i.e., two UWB sensors) are able to detect the target 306. In various embodiments, activation 330 is performed with respect to two of the sensors 116 of the second type 119 (e.g., two UWB sensors) that provide detection and localization for the target 306. In addition, as depicted in FIG. 3, within the fourth stage 304 the localization is also assisted by continued scanning and localization of the target 306 by multiple sensors 116 of the first type 118 (e.g., multiple RSSI sensors), for example corresponding to region 344 as illustrated in FIG. 3.

Also as depicted in FIG. 3, the fifth stage 305 (also as referred to in the process 200 of FIG. 2) occurs when the target is still closer (i.e., less than the fourth predetermined threshold distance of the fourth stage 304) from the vehicle 100 (or, in various embodiments, away from particular respective sensors 116), such that detection and localization of the target 306 can now be performed by at least three sensors 116 of the second type 119. In various embodiments, localization of the target 306 is performed via triangulation via the three or more sensors 116 of the second type 119. In various embodiments, this is executed via the processor 122 of FIG. 1. Also in various embodiments, the localization (e.g., triangulation) is also assisted by continued scanning and localization of the target 306 by multiple sensors 116 of the first type 118 (e.g., multiple RSSI sensors), for example corresponding to region 354 as illustrated in FIG. 3.

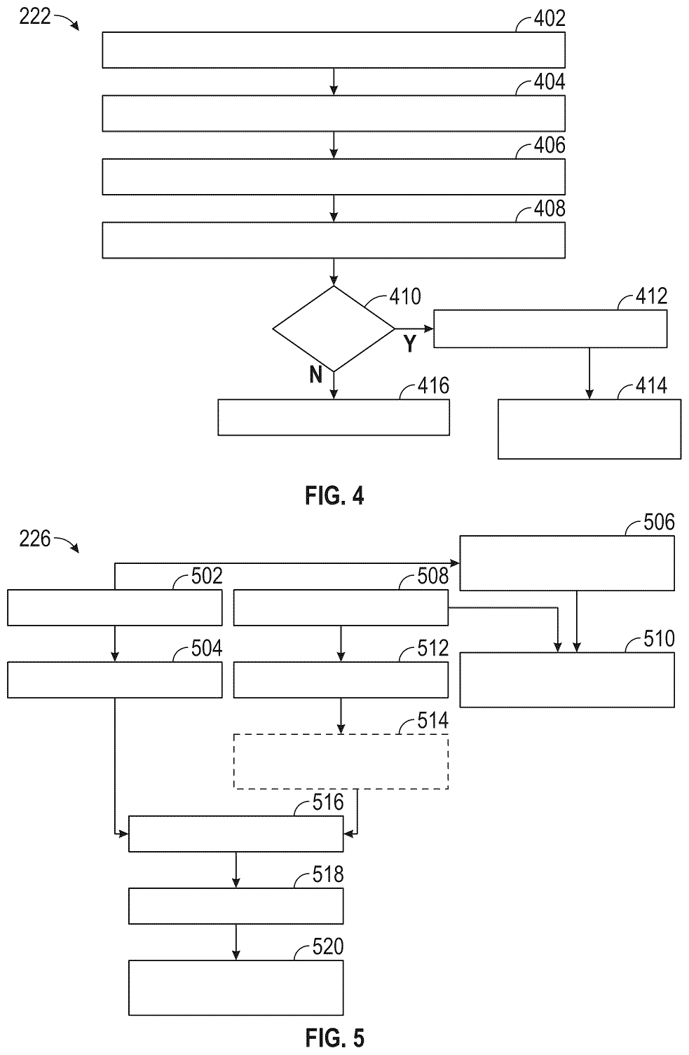

FIG. 4 is a flowchart of an exemplary sub-process of the process 200 of FIG. 2 (corresponding to step 222 of FIG. 2), namely localization in the particular first and second stages 301 and 302 of FIG. 3, in accordance with exemplary embodiments.

As depicted in FIG. 4, initial determinations are performed with respect to the sensors 116 of the first type 118 (step 402). In various embodiments, this step corresponds to step 210 of FIG. 2, in which initial determinations of the location of the target are obtained or determined with respect to the first measurements of step 208 (e.g., with respect to initial RSSI location determinations).

Also in various embodiments, feature extraction is performed (step 404). In various embodiments, this step corresponds to step 216 of FIG. 2, in which the processor 122 of FIG. 1 performs feature extraction from the first measurements of step 208 and the initial determinations of step 210 (e.g. step 402) above. In various embodiments, the feature extraction pertains to detection and initial localization of one or more targets (e.g., one or more people, other vehicles, and/or other objects) in proximity to the vehicle 100.

Also in various embodiments, a path loss model is implemented and/or updated (step 406). In various embodiments, the path loss model comprises a neural network. Also in various embodiments, this step corresponds to step 220 of FIG. 2, in which the processor 122 of FIG. 1 updates a path loss matter for the sensors 116 of the first type 118 (e.g., RSSI sensors), using the real-time training of step 218.

In various embodiments, a determination is made as to whether the target is within a core region (step 410). In various embodiments, during this step, the processor 122 of FIG. 1 determines whether the target 306 of FIG. 3 is within the second region 312 of FIG. 3 (i.e., within a predetermined distance of the vehicle 100 and/or applicable sensors 116 such that one or more sensors 116 of the second type 119 can detect the target 306).

If it is determined in step 410 that the target is within the core region, then in an exemplary embodiment initialized is triggered and provided for one or more of the sensors 116 of the second type 119. Specifically, in various embodiments, the processor 122 initiates utilization of one or more of the sensors 116 of the second type 119 (e.g., one or more UWB sensors). Also in various embodiments, localization is then performed in step 414 via the processor 222 using sensors 116 of both the first type 118 (e.g., RSSI sensors) and the second type 119 (e.g., UWB sensors), thereby resulting in two-tier accurate localization of the target 306.

Conversely, if it is instead determined in step 410 that the target is not within the core region, then in an exemplary embodiment localization is provided by the processor 122 in step 416 only using sensors 116 of the first type 118 (e.g., RSSI sensors), thereby resulting one-tire localization (e.g., providing a rough location of the target 306).

In an exemplary embodiment, as part of (or following) the localization of either step 414 or 416, one or more vehicle control actions are provided for the vehicle based on the localization of the target, such as (A) providing one or more notifications for a driver or other passengers of the vehicle 100 via the display system 120 of FIG. 1 (e.g., one or more audio, visual, and/or haptic notifications) in accordance with instructions provided by the processor 122); and/or (B) executing one or more vehicle movement commands for adjustments to motor/propulsion torque, braking torque, and/or steering angle via the drive system 114 (and/or one more motors, braking systems, steering systems, and/or other systems thereof or coupled thereto) in accordance with instructions provided by the processor 122.

FIG. 5 is a flowchart of another exemplary sub-process of the process 200 of FIG. 2 (corresponding to step 226 of FIG. 2), namely localization in particular third and fourth stages 303 and 304 of FIG. 3, in accordance with exemplary embodiments. With reference to FIG. 5, in an exemplary embodiment the steps depicted in FIG. 5 are performed with respect to each of the sensors 116 of the vehicle 100 of FIG. 1.

As depicted in FIG. 5, in an exemplary embodiment, initial determinations are performed with respect to the sensors 116 of the first type 118 (step 502). In various embodiments, this step corresponds to steps 402 of FIG. 2 and step 210 of FIG. 2, in which initial determinations of the location of the target are obtained or determined with respect to the first measurements of step 208 (e.g., with respect to initial RSSI location determinations).

Also in various embodiments, observed patterns are identified (step 504). In various embodiments, the processor 122 observes patterns in the sensor data obtained from the sensors 116 of the first type 118 (e.g., RSSI sensors), using the initial determinations of step 502.

Also in an exemplary embodiment, feature extraction is performed (step 506). In various embodiments, this step corresponds to step 404 of FIG. 4 and step 216 of FIG. 2. Also in various embodiments, during step 506, the processor 122 of FIG. 1 performs feature extraction from the initial determinations of steps 502 and the pattern observations determinations of step 504.

Also in various embodiments, initial determinations of the location of the target are made via the sensors 116 of the second type 119 (e.g., one or more UWB sensors) (step 508). In certain embodiments, step 508 corresponds to step 214 of FIG. 2, and includes making the initial determinations via two-way ranging with respect to the second measurements of step 212 of FIG. 2 (e.g., with respect to initial UWB location determinations).

Also in various embodiments, one or more distances from the initial determinations of step 508 are used for updating the pass loss model (step 510). In various embodiments, during step 510, the processor 122 utilizes the distance to update the pass loss model of steps 220 of FIGS. 2 and 406 of FIG. 4. As noted above, in various embodiments the pass loss model comprises a neural network model.

Also as depicted in FIG. 5, in various embodiments potential locations are provided for the target (step 512). In various embodiments, this corresponds to step 230 of FIG. 2, described above. Also in various embodiments, step 512 is performed via the processor 122 of FIG. 1. Specifically, in various embodiments, the processor 122 uses the initial determinations of step 508 from the sensors 116 of the second type 119 (e.g., the UWB sensors) in determining a plurality of potential locations (also referred to as candidate locations) for the position or location of the target 306 with respect to the vehicle 100.

In various embodiments, estimated patterns are determined (step 514). Specifically, in various embodiments, during step 514, the processor 122 predicts estimated patterns of sensor data from the sensors 116 of the first type 118, using the sensor data from the sensors 116 of the second type 119 (and specifically including the updated path loss model of step 510 and the potential locations of step 512). In various embodiments, respective estimated patterns are predicted for each of the potential locations.

Also in various embodiments, pattern matching is performed (step 516). Specifically, in various embodiments, the observed patterns of the data of the sensors 116 of the first type 118 (from step 504) are compared with the predicted patterns of the data of the sensors 116 of the first type 118 (from step 514). In various embodiments, the pattern matching is performed by the processor 122 with respect to each of the potential locations of step 512.

In various embodiments, location selection is performed (step 518). Specifically, in various embodiments, the processor 122 selects one of the potential locations of step 512 as being the most likely location of the target, based on the pattern matching of step 516. In an exemplary embodiment, the potential location with the closest matching between is respective observed pattern versus estimated pattern is determined to be most likely location of the target.

In various embodiments, localization is performed (step 520). In various embodiments, the processor 122 performs further localization of the targe with respect to the selected location of step 518, utilizing sensors 116 of both the first type 118 and the second type 119 (thereby providing two-tier accurate location of the target). Also in various embodiments, one or more vehicle control actions are then provided for the vehicle based on the localization of the target, such as (A) providing one or more notifications for a driver or other passengers of the vehicle 100 via the display system 120 of FIG. 1 (e.g., one or more audio, visual, and/or haptic notifications) in accordance with instructions provided by the processor 122); and/or (B) executing one or more vehicle movement commands for adjustments to motor/propulsion torque, braking torque, and/or steering angle via the drive system 114 (and/or one more motors, braking systems, steering systems, and/or other systems thereof or coupled thereto) in accordance with instructions provided by the processor 122.

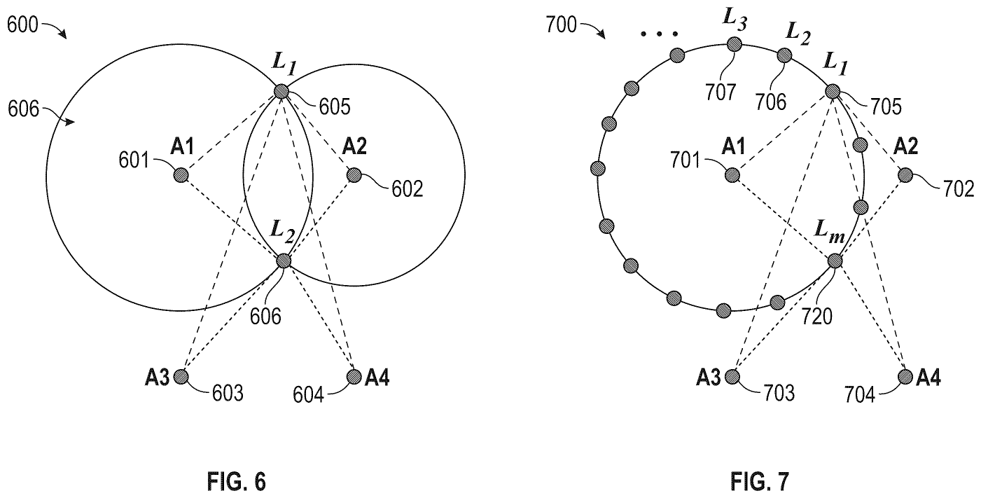

FIGS. 6, 7, 8A, 8B, 9A, 9B, and 9C depict exemplary implementations of pattern matching associated with steps of the process 200 of FIGS. 2-5 (including the pattern matching of step 516 of FIG. 5), in accordance with exemplary embodiments.

With respect first to FIG. 6, an exemplary illustration 600 pertains to an implementation in which there are four sensor locations A1 (601), A2 (602), A3 (603), and A4 (604). The sensors of the second type 119 propose two candidate locations, namely: L1 (605) and L2 (606). In various embodiments, the sensor data of the sensors of the first type 118 are utilized to determine which of the two candidate locations, namely L₁ (605) or L₂ (606) are correct. In various embodiments, this is performed using the following equations:

Theoretically predicted

$${RSSI}_{p}^{{L}_{1}} = 〈 {rssi}_{{A}_{1}}^{{L}_{1}} , r s s {i}_{{A}_{2}}^{{L}_{1}} , r s s {i}_{{A}_{3}}^{{L}_{1}} , r s s {i}_{{A}_{4}}^{{L}_{1}} 〉$$

if target is located at L1 (based on RSSI path loss model, trained by NN or LS on each sensor) (Equation 1);

Theoretically predicted

$$R S S {I}_{p}^{{L}_{2}} = 〈 {rssi}_{{A}_{1}}^{{L}_{2}} , r s s {i}_{{A}_{2}}^{{L}_{2}} , r s s {i}_{{A}_{3}}^{{L}_{2}} , r s s {i}_{{A}_{4}}^{{L}_{2}} 〉$$

if target is located at L2 (based on RSSI path loss model, trained by NN or LS on each sensor) (Equation 2);

Sensor observed RSSI sequences

$${RSSI}_{o} 〈 {rssi}_{o}^{{t}_{1}} , rss {i}_{o}^{{t}_{2}} , rss {i}_{o}^{{t}_{3}} , … , rss {i}_{o}^{{t}_{n}} 〉 ; \qquad ( Equation 3 )$$

and

$${S}^{{L}_{m}} = Fit ( {RSSI}_{p}^{{L}_{m}} , RSS {I}_{o} ) = {\sum }_{i = {t}_{1}}^{{t}_{n}} {\sum }_{j = 1}^{4} \vert {rssi}_{0}^{i} - r s s {i}_{p}^{j} \vert for any i == j , where m = 1 , 2. \qquad ( Equation 4 )$$

With reference to FIG. 7, a similar example is illustrated with various sensors A1 (701), A2 (702), A3 (703), and A4 (704), with any number of possible candidate values L₁ (705), L₂ (706), L₃ (707), . . . . Lₘ (720), and so on.

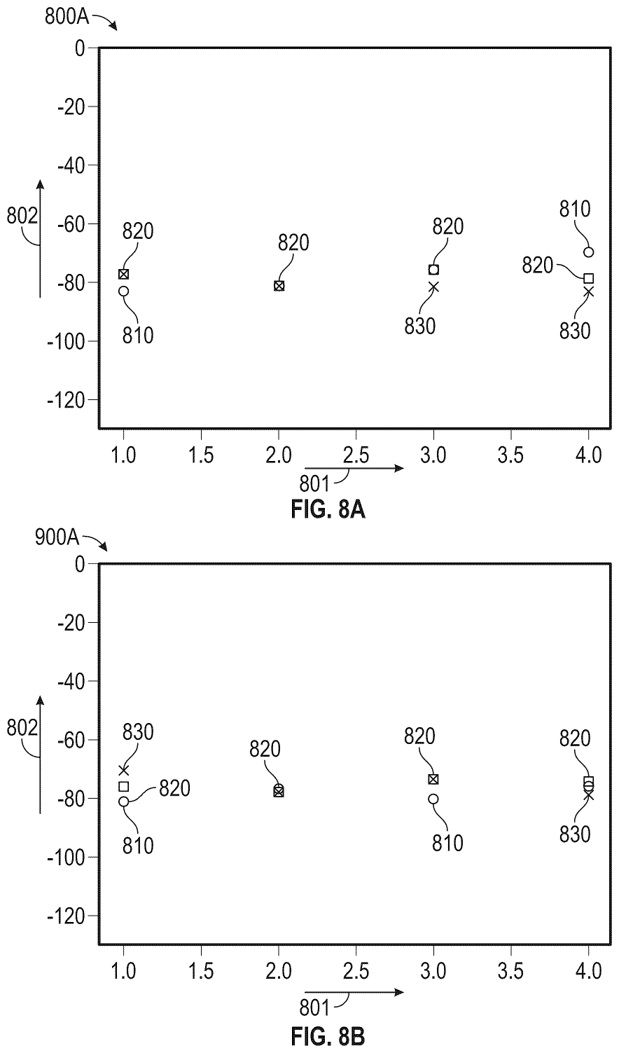

FIGS. 8A and 8B also depict exemplary implementations of pattern matching associated with steps of the process 200 of FIGS. 2-5 (including the pattern matching of step 516 of FIG. 5), in accordance with exemplary embodiments. Specifically, in an exemplary embodiment: (i) FIG. 8A depicts a first illustration 800(A) with first RSSI patterns with respect to a first candidate L₁ location based on UWB data from one or more first UWB sensors; and (ii) FIG. 8A depicts a second illustration 800(B) with respect to second RSSI patterns respect to a second candidate location L₂ based on UWB data from one or more second UWB sensors. In both of these figures: the X-axis is represented by 801; the Y-axis is represented by 802, the sensed RSSI locations values are represented by 810, the true RSSI location values are represented by 820, and false RSSI location RSSI values are represented by 830. In the depicted example, the first candidate location L₁ provides a better fit than the second candidate location L₂, because the sums of errors of the first candidate location L₁ are smaller than those of the second candidate location L₂.

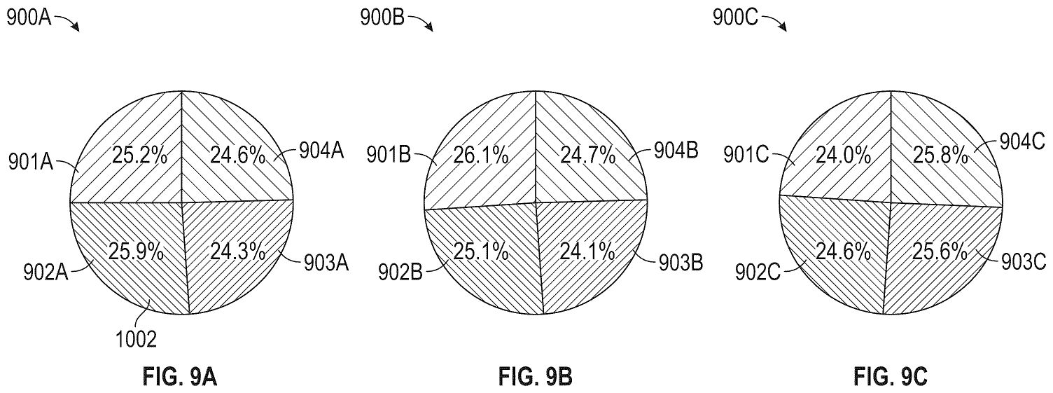

FIGS. 9A, 9B, and 9C provide further illustrations of the pattern matching, with respect to the illustrative example of FIGS. 8A and 8B. Specifically: (i) FIG. 9A provides a first representation 900(A) with an RSSI ratio chart of the first candidate location L₁; (ii) FIG. 9B provides a second representation 900(B) with an RSSI ratio chart of the second candidate location L₂; and (iii) FIG. 9C provides a third representation 900(C) with an RSSI ratio chart of the observed RSSI data. In each of these three figures: (i) a first quadrant (901(A), 901(B), or 901(C), respectively) represents the respective ratio with respect to a first sensor; (ii) a second quadrant (902(A), 902(B), or 902(C), respectively) represents the respective ratio with respect to a second sensor; (iii) a third quadrant (903(A), 903(B), or 903(C), respectively) represents the respective ratio with respect to a third sensor; and (iv) a fourth quadrant (904(A), 904(B), or 904(C), respectively) represents the respective ratio with respect to a fourth sensor. In the illustrative example, the first candidate location L₁ provides a better fit than the second candidate location L₂, because the RSSI component ratios/distributions of the first candidate location L₁ are closer to the actual/observed values.

Accordingly, methods, systems, and vehicles are provided for detection and localization of targets in proximity to a vehicle or other platform. As depicted in the figures and as described above in connection therewith, in various embodiments, the disclosed methods and systems utilize sensors in different modalities in combination with one another for detecting the target in proximity to the platform. In certain embodiments the platform comprises a vehicle, and the methods and systems use combinations of different types of sensors (e.g., RSSI sensors and UWB sensors) for detecting and localization the target at different distances from the vehicle.

It will be appreciated that the systems, vehicles, and methods may vary from those depicted in the Figures and described herein. For example, the vehicle 100 of FIG. 1, including the control system 101, controller 102 and/or other components thereof, may vary in different embodiments from that depicted in FIG. 1 and/or described above in connection therewith. It will similarly be appreciated that the steps of the process 200 and implementations thereof may differ from those depicted in FIGS. 2-9(C), and/or that various steps of the process 200 may occur concurrently and/or in a different order than that depicted in FIGS. 2-9(C) and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining, via one or more first sensors of a platform, first sensor data as to a target with respect to the platform, the one or more first sensors having a first modality;
obtaining, via one or more second sensors of the platform, second sensor data with respect to the target, the one or more second sensors having a second modality that is different from the first modality; and
localizing the target, via a processor of the platform, using the first sensor data and the second sensor data, in which the second sensor data is utilized to enhance the first sensor data based on an effectiveness of the first sensor data, and that is based on a distance of the target from the platform;
wherein the one or more first sensors of the first modality are configured for detecting the target at a relatively larger distance from the platform as compared with the one or more second sensors of the second modality; and
the one or more second sensors of the second modality are configured for detecting the target at a relatively greater accuracy from short distances as compared with the one or more first sensors of the first modality.

2. The method of claim 1, wherein the platform comprises a vehicle, and the processor is further configured to at least facilitate performing a control action with respect movement of the vehicle based on the localizing of the target with respect to the vehicle.

3. The method of claim 2, wherein the one or more second sensors of the second modality comprise ultra-wide band (UWB) sensors.

4. The method of claim 3, wherein the one or more first sensors of the first modality comprise RSSI sensors.

5. The method of claim 1, wherein:
the second sensor data is utilized via the processor to identify a plurality of candidate locations for the target; and
the first sensor data is utilized via the processor to select a preferred candidate of the plurality of candidate locations based on pattern matching for the second sensor data using a path loss model.

6. The method of claim 5, wherein the localizing is performed via the processor using:
only the first sensor data, and not the second sensor data, when the target is greater than a first predetermined distance from the platform; and
both the first sensor data and the second sensor data, when the target is less than the first predetermined distance from the platform.

7. The method of claim 6, wherein the localizing is performed via the processor using:
the first sensor data from a single first sensor of the first modality, when the target is greater than the first predetermined distance from the platform and is also greater than a second predetermined distance from the platform, wherein the second predetermined distance is greater than the first predetermined distance; and
the first sensor data from multiple sensors of the first modality, when the target is greater than the second predetermined distance from the platform.

8. The method of claim 7, wherein the localizing is performed via the processor using:
the first sensor data from multiple first sensors of the first modality, along with the second sensor data from a single second sensor of the second modality, when the target is less than the first predetermined distance from the platform but greater than a third predetermined distance from the platform, wherein the third predetermined distance is less than the first predetermined distance; and
the first sensor data from multiple first sensors of the first modality, along with the second sensor data from multiple second sensors of the second modality, when the target is less than the first predetermined distance from the platform and less than the third predetermined distance from the platform.

9. The method of claim 8, wherein the localizing is performed via the processor using:
the first sensor data from multiple first sensors of the first modality, along with the second sensor data from two second sensors of the second modality, when the target is less than the third predetermined distance from the platform but greater than a fourth predetermined distance from the platform, wherein the fourth predetermined distance is less than the third predetermined distance; and
the first sensor data from multiple first sensors of the first modality, along with the second sensor data from at least three second sensors of the second modality, by applying triangulation with respect to the second sensor data from the at least three second sensors, when the target is less than the fourth predetermined distance from the platform.

10. A system comprising:
one or more first sensors of a platform, the one or more first sensors having a first modality and configured to obtain first sensor data as to a target with respect to the platform;
one or more second sensors of the platform, the one or more second sensors having a second modality that is different from the first modality and configured to obtain second sensor data as to the target with respect to the platform, and wherein the second sensors of the second modality are configured for detecting the target at a relatively greater accuracy from short distances as compared with the first sensors of the first modality; and
a processor of the platform that is coupled to the one or more first sensors and to the one or more second sensors and that is configured to at least facilitate localizing the target, using the first sensor data and the second sensor data, in which the second sensor data is utilized to enhance the first sensor data based on an effectiveness of the first sensor data, and that is based on a distance of the target from the platform.

11. The system of claim 10, wherein the platform comprises a vehicle, and the processor is further configured to at least facilitate performing a control action with respect movement of the vehicle based on the localizing of the target with respect to the vehicle.

12. The system of claim 10, wherein the one or more second sensors of the second modality comprise ultra-wide band (UWB) sensors.

13. The system of claim 12, wherein the one or more first sensors of the first modality comprise RSSI sensors.

14. The system of claim 10, wherein:
the second sensor data is utilized via the processor to identify a plurality of candidate locations for the target; and
the first sensor data is utilized via the processor to select a preferred candidate of the plurality of candidate locations based on pattern matching for the second sensor data using a path loss model.

15. The system of claim 14, wherein the localizing is performed via the processor using:
only the first sensor data, and not the second sensor data, when the target is greater than a first predetermined distance from the platform; and
both the first sensor data and the second sensor data, when the target is less than the first predetermined distance from the platform.

16. The system of claim 15, wherein the localizing is performed via the processor using:
the first sensor data from a single first sensor of the first modality, when the target is greater than the first predetermined distance from the platform and is also greater than a second predetermined distance from the platform, wherein the second predetermined distance is greater than the first predetermined distance; and
the first sensor data from multiple first sensors of the first modality, when the target is greater than the second predetermined distance from the platform.

17. The system of claim 16, wherein the localizing is performed via the processor using:
the first sensor data from multiple first sensors of the first modality, along with the second sensor data from a single second sensor of the second modality, when the target is less than the first predetermined distance from the platform but greater than a third predetermined distance from the platform, wherein the third predetermined distance is less than the first predetermined distance; and
the first sensor data from multiple first sensors of the first modality, along with the second sensor data from multiple second sensors of the second modality, when the target is less than the first predetermined distance from the platform and less than the third predetermined distance from the platform.

18. The system of claim 17, wherein the localizing is performed via the processor using:
the first sensor data from multiple first sensors of the first modality, along with the second sensor data from two second sensors of the second modality, when the target is less than the third predetermined distance from the platform but greater than a fourth predetermined distance from the platform, wherein the fourth predetermined distance is less than the third predetermined distance; and
the first sensor data from multiple first sensors of the first modality, along with the second sensor data from at least three second sensors of the second modality, by applying triangulation with respect to the second sensor data from the at least three second sensors, when the target is less than the fourth predetermined distance from the platform.

19. A platform comprising:
a body;
one or more first sensors disposed within the body, the one or more first sensors having a first modality and configured to obtain first sensor data as to a target with respect to the platform;
one or more second sensors disposed within the body, the one or more second sensors having a second modality that is different from the first modality and configured to obtain second sensor data as to the target with respect to the platform, and wherein the second sensors of the second modality are configured for detecting the target at a relatively greater accuracy from short distances as compared with the first sensors of the first modality; and
a processor disposed within the body, the processor coupled to the one or more first sensors and to the one or more second sensors and that is configured to at least facilitate localizing the target, using the first sensor data and the second sensor data, in which the second sensor data is utilized to enhance the first sensor data based on an effectiveness of the first sensor data, and that is based on a distance of the target from the platform.

20. The platform of claim 19, wherein the platform comprises a vehicle, and the processor is further configured to at least facilitate performing a control action with respect movement of the vehicle based on the localizing of the target with respect to the vehicle.
